(19) United States
(12) Patent Application Publication
(10) Pub. No.: US 2020/0208517 A1
(43) Pub. Date: Jul. 2, 2020

(54) UNDERGROUND VERTICAL SHAFTS AND NUCLEAR REACTORS USING THE SAME

(71) Applicant: GE-Hitachi Nuclear Energy Americas LLC, Wilmington, NC (US)

(72) Inventors: Christer N. Dahlgren, Wilmington, NC (US); Douglas B, McDonald, Wilmington, NC (US); Tatjana B. Kirby, Wilmington, NC (US); Gary M. Anthony, Wilmington, NC (US)

(21) Appl. No.: 16/237,637

(22) Filed: Dec. 31, 2018

(51) Int. Cl. E21D 1/10; G21C 1/02; G21C 13/093; G21C 15/18

(52) U.S. Cl. CPC E21D 1/10; G21C 15/18; G21C 13/093; G21C 1/02

(57) ABSTRACT

Nuclear power plants include vertical shafts housing a reactor and plant equipment connected between the shafts. Shafts may be formed with VSM to nuclear standards, and a basemat may be poured at the bottom, which is compatible with reactor designs such as a simplified boiling water reactors, small modular reactors, advanced reactors and sodium cooled fast reactors. Additional plant systems may be placed in further shafts and connected through side-travelling tunnels that pass through the shafts. The plant may be segregated by safety class among different shafts. Floors, which may be modular and prefabricated with full equipment for delivery at the shaft, may be vertically lowered into appropriate shafts and seated to walls of the shaft. Equipment can be connected between floors by running connections along shaft walls.

### BACKGROUND

FIG. 1 is a schematic view of a related art deep shaft constructor system 1, such as a vertical shaft sinking machine (VSM). As shown in FIG. 1, support concrete ring beam 2 may be formed at a top of an area desired for a vertical shaft. A cutting or boring machine 10 is then lowered in the middle of ring beam 2. Rotatable cutter boom 11 and cutter drum 12 may then move about the edges and bottom of the ground, excavating soil, rock, clay, etc. to form space for shaft 5. Simultaneously, precast shaft segments 3 or in situ concrete may be placed at the top of a stack of shaft 5. As boring machine 10 descends and excavates, shaft 5 is thus also lengthened and descended. Integrated cutting edge 4 at a bottom of shaft 5 may aid in dividing the ground and allowing vertical displacement of shaft 5. Strand jack 40 may lift and lower shaft 5 by cutting edge 4, controlling the descent of shaft 5. Winches 20 may similarly lift machine 10 to desired excavating depths, as well as providing power and control to machine 10. Slurry station 30 may suction and process excavated material from shaft 5.

Shaft 5 may be filled with water during excavation, such that cutter boom 11 and drum 12 are underwater. This may aid in excavation collection and processing, as well as prevent groundwater leakage into shaft 5 that may occur if filled with air. As such, shaft 5 may be continuously formed and lowered while space is being created by machine 10, allowing deep vertical shafts with concrete linings to be formed relatively quickly. Shaft 5 may be 4.5-22 meters in diameter, and up to 80 meters deep. An example of related art deep shaft constructor system 1 is the Herrenknecht VSM, as described in “Herrenknect VSM” (available at herrenknecht.com/en/products/productdetail/vertical-shaft-sinking-machine-vsm/) and incorporated herein by reference in its entirety.

### SUMMARY

Example embodiments include nuclear installations, such as electrical generating plants using nuclear reactors, using one or more vertical shafts that are built vertically downward by forming the shaft at its top and descending the shaft. The shaft-creating process may use a vertical shaft sinking machine that excavates ground under the shaft and vertically lowers the shaft as the ground is removed. A blade or wedge on the shaft may facilitate this vertical descent. A basemat may be poured at a bottom of this shaft, potentially to cover the wedge and support reactor components. The basemat may be covered with materials to prevent degradation of the basemat by overheated nuclear core reactor debris that may fall onto the basemat. The entire reactor and buildings formed by the shaft(s) may thus be underground. Because vertical shafts formed by excavation and descent may be smaller, such as up to 22 meters in diameter, smaller reactors along with containment structures may be used, such as advanced reactors, small modular reactors, PRISM, or BWRX-300 designs, that can fit in such shafts. Additional plant systems may be placed in further shafts and connected through horizontal tunnels that pass through the shafts. For example, one shaft may include safety equipment of a particular class, and another shaft may include electrical generating equipment with no safety classification, and the different shafts may be outfitted based on the different safety classes of equipment therein.

Buildings formed by the vertical shafts can use modular floors that are potentially fabricated offsite in a modular fashion with equipment pre-installed and shipped ready for installation. Each floor may be vertically lowered into the appropriate shaft and attached to walls of the shaft. Equipment can be connected between floors by running connections along shaft walls. Because floors may be modular and prefabricated, their manufacturing, shipping, and installation of the floors may not interfere with construction of vertical shafts that will house the same. Less costly methods, such as VSM, may be used to quickly fabricate the shafts followed by quick installation of all plant equipment on a series of floors in connected vertical shafts.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a related art deep shaft constructor system.

FIG. 2 is a plan view of an example embodiment nuclear facility using vertical shafts.

FIG. 3 is a profile schematic of an example embodiment nuclear facility using vertical shafts.

### DETAILED DESCRIPTION

Because this is a patent document, general, broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the terms “and,” “or,” and “and/or” include all combinations of one or more of the associated listed items unless it is clearly indicated that only a single item, subgroup of items, or all items are present. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

As used herein, the singular forms “a,” “an,” and the are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, “axial” and “vertical” directions are the same up or down directions oriented along the major axis of a nuclear reactor, often in a direction oriented with gravity. “Transverse” directions are perpendicular to the “axial” and are side-to-side directions at a particular axial height.

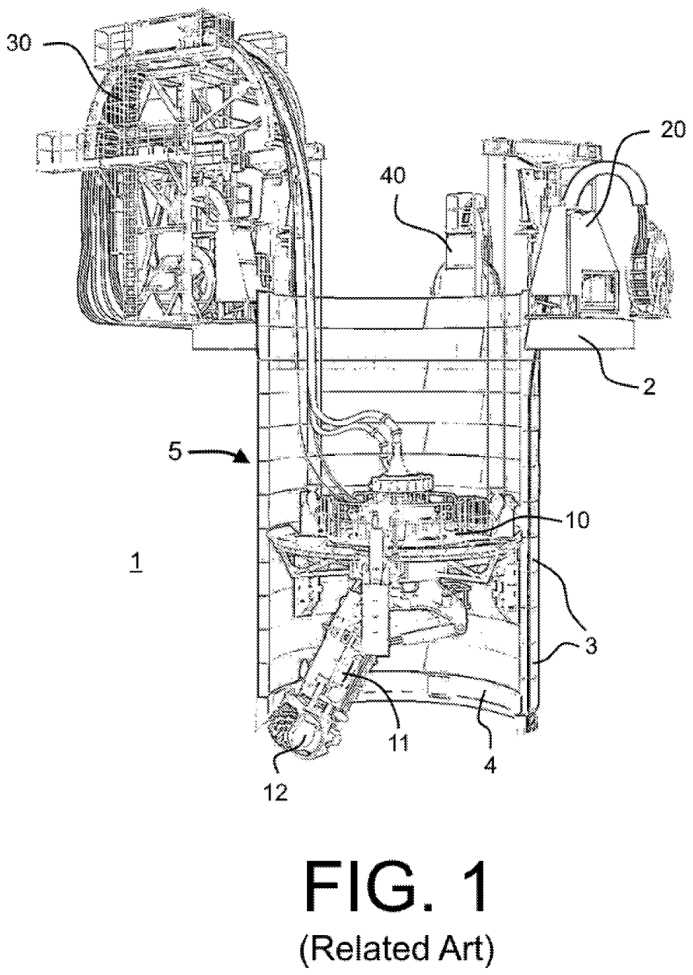

The Inventors have newly recognized that related art reactors with large above-ground structures represent an accident vector due to aircraft strikes, weather, attacks facilitated by their accessible position, and radioactive leakage to surrounding atmosphere. The Inventors have further recognized extreme costs associated with underground tunneling and construction in a vertical direction that might avoid these above-ground risks. Although related art VSM having top-down shaft construction described in connection with FIG. 1 is more economical, for a conventional commercial nuclear plant, arranging all plant components in a single vertical shaft may eliminate separation safeguards and/or require more space than available through VSM, and several sensitive systems may have to be operated above ground, further complexifying the plant. Example embodiments described below uniquely enable solutions to these and other problems discovered by the Inventors.

The present invention is nuclear facilities using vertical shaft(s) and methods of constructing the same. In contrast to the present invention, the few example embodiments and example methods discussed below illustrate just a subset of the variety of different configurations that can be used as and/or in connection with the present invention.

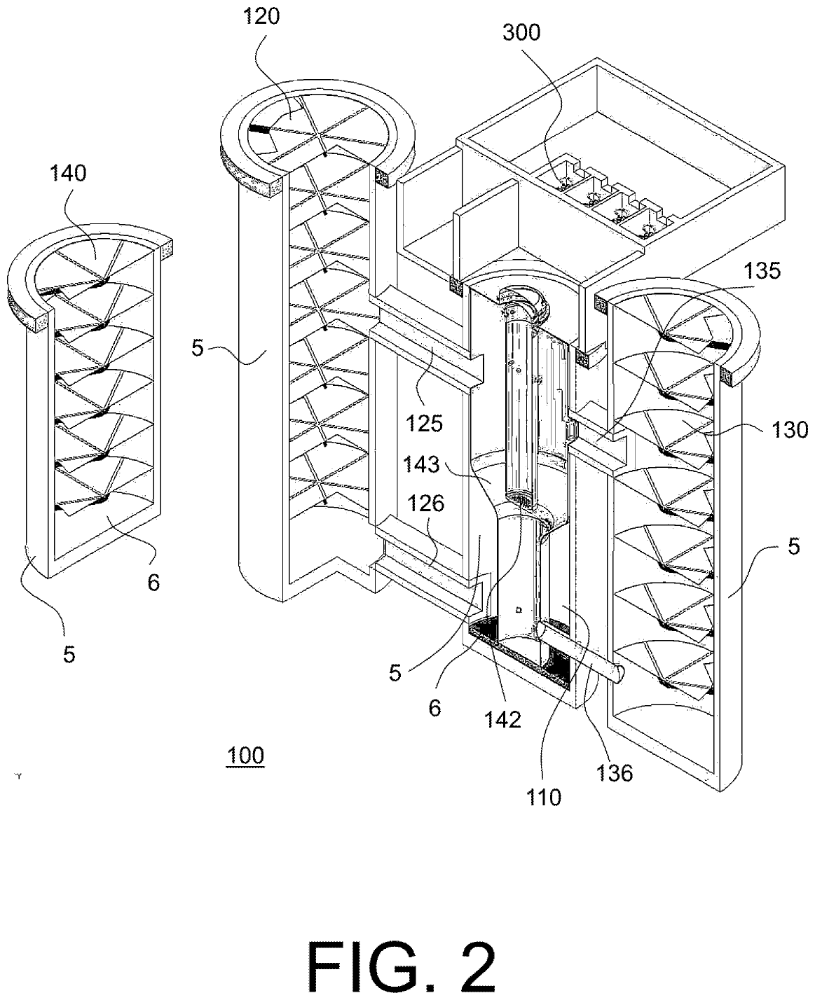

FIG. 2 is an illustration of an example embodiment nuclear facility 100, such as a commercial nuclear power plant. As seen in FIG. 2, multiple vertical shafts 5 are used to house various plant components. Shafts 5 are fabricated with related art deep shaft constructor 1 of FIG. 1; for example, shafts 5 may be excavated and, in parallel, descended with a VSM as described in connection with FIG. 1. As such, shafts 5 may be underground and of significant diameter and depth, on the order of 10-22 meters and 50-80 meters, respectively, to house large volumes of plant components. Shafts 5 may be formed of pre-formed segments sequentially stacked to form shaft 5, or, in the case of housing a reactor or sensitive nuclear components, regulation-grade continuously-poured rebar concrete forming a continuous, impermeable barrier. If underground as shown in FIG. 2, example embodiment facility 100 may present an exceedingly small strike target and/or be hardened against surface impacts and explosions. Further, if underground, example embodiment facility 100 may have additional containment against radioactive release and enable easier flooding in the case of emergency cooling.

Central reactor building 110 is formed of shaft 5 and basemat 6 and houses nuclear reactor 142, containment 143, and/or closely-related safety class I equipment, such as control rods and associated drives. Shaft 5 in reactor building 110 is fabricated of materials that are compatible with a nuclear reactor environment, including materials that maintain their physical characteristics when exposed to high-temperature materials and radiation, such as stainless steels and iron alloys, aluminum alloys, zirconium alloys, high-quality concrete, etc. Shaft 5 may also be fabricated of a thickness, such as a meter or more, that ensures minimal leakage in any direction across shaft 5. For example, reactor building 110 may be formed with shaft 5 of seismic-grade and leakage-proof concrete continuously poured, potentially with rebar, in a descending annulus while excavation is performed with a VSM or the like. Shaft 5 may also be lined with stainless steel plates and/or additional radiation shielding sequentially added during construction or after.

Reactor 142 may be any type of reactor sized to fit within building 110, and as such, is likely 22 meters or less in total diameter. For example, reactor 142 may be a simplified Boiling Water Reactor as described in co-owned application Ser. No. 15/585,162 to Hunt, Dahlgren, and Marquino, filed May 2, 2017 for VERY SIMPLIFIED BOILING WATER REACTORS FOR COMMERCIAL ELECTRICITY GENERATION; Ser. No. 15/635,400 to Hunt, Dahlgren, and Marquino, filed Jun. 28, 2017 for ISOLATION CONDENSER SYSTEMS FOR VERY SIMPLIFIED BOILING WATER REACTORS; and Ser. No. 15/677,380 to Hunt, Dahlgren, and Marquino filed Aug. 15, 2017 for DEPRESSURIZATION AND COOLANT INJECTION SYSTEMS FOR VERY SIMPLIFIED BOILING WATER REACTORS, all incorporated by reference herein in their entireties. Such simplified reactors and associated integral valves may fit in a smaller building 110 bounded by shaft 5 of up to a 22 meter diameter formed by a deep shaft constructor system. Of course, other PRISM and LWR small module reactors may be used for reactor 142 in a smaller shaft 5; further conventional and large scale reactors, such as an ESBWR, are useable in facility 100 with a larger shaft 5, which may potentially well exceed 22 meters.

Basemat 6 in reactor building 110 may be poured concrete at a bottom of shaft 5. In connection with a VSM creating shaft 5, basemat 6 may be directly poured following excavation and descending of shaft 5. Basemat 6 may also include emergency cooling and/or ablation-resistant materials and features to mitigate decay heat buildup in the unlikely event of core relocation out of reactor 142, such as that described in co-owned patent publication 2011/0150165 published Jun. 23, 2011 to Theofanous et al. As shown in FIG. 2, building 110 may be partially filled below reactor 142 where additional volume is unnecessary, down to basemat 6. All of basemat 6 and shaft 5 of reactor building 110 may be underground or partially buried.

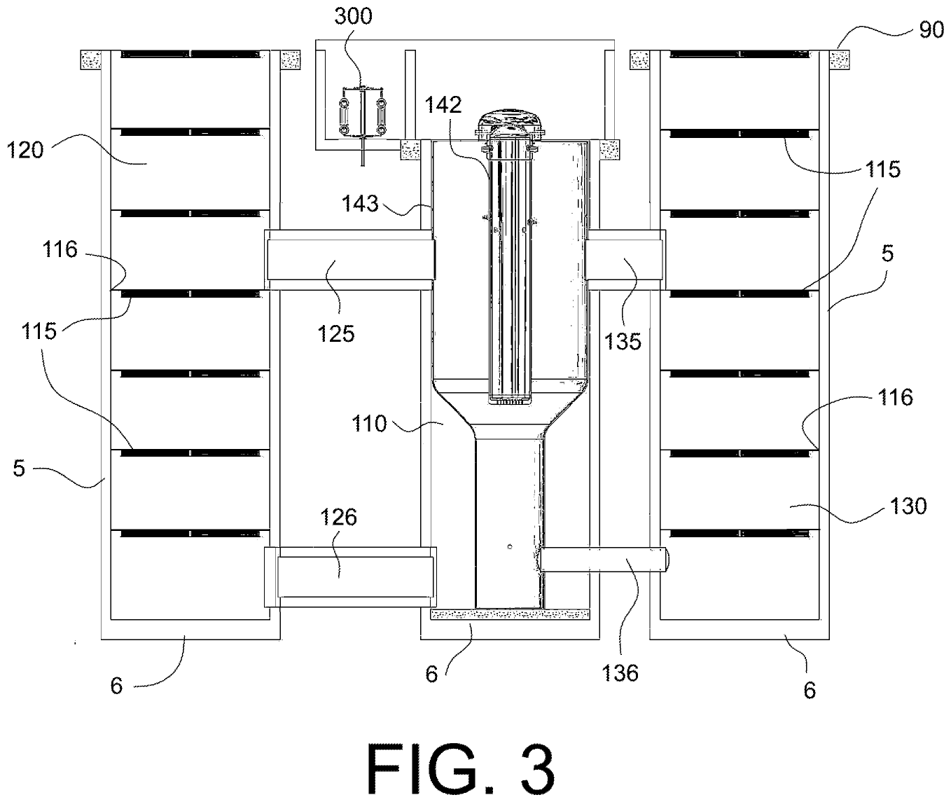

Containment 143 may enclose reactor 142 in building 110 to provide further protection about reactor 142. Although containment 143 is shown as a separate structure, walls of shaft 5 may themselves be a containment boundary (or an additional containment boundary) of the nuclear reactor when fabricated of resilient materials and impermeable standards. A concrete lid, surface building, or other surface shield level with, or below, ground 90 (FIG. 3) may enclose reactor building 110 and/or containment 143 housing reactor 142. Reactor 142 may be accessible through this lid during maintenance and construction. Emergency and/or passive isolation condenser systems 300, emergency cooling pools, and other coolant or operating systems may be positioned above building 100 as shown in FIG. 2 and/or in another auxiliary building 120 or 130 (described below) to connect to reactor 142.

A single vertical bore and shaft 5 may be limiting for operating all systems associated with a nuclear reactor, especially if limited to a 22-meter diameter or less using VSM. In such case, other reactor components may be installed and operated above ground. Alternatively, multiple shafts 5 may be used in example embodiment facility 100 to create multiple distinct buildings 110, 120, 130, and 140 that can all house and connect various reactor and power-generating equipment. Of course, as discussed above, larger shafts, however created, may accommodate all reactor components and plant equipment in a single shaft in example embodiment facility 100.

Some equipment may be positioned in auxiliary buildings 120 and 130, which may also be formed with shafts 5 excavated underground about reactor building 110. For example, one auxiliary building 120 may house reactor coolant cleanup systems and control rod drive pumps, while another auxiliary building 130 may include power generating turbines and condensers for the main coolant loop. Control building 140 may be similarly formed and house a spent fuel pool, control room, and/or other plant equipment. Alternatively, auxiliary buildings 120 and 130 and control building 140 may include any division of equipment and may be of any number and positioning about reactor building 110. Buildings 120, 130, and 140 may be equipped based on nuclear safety requirements and/or risk level, as defined in nuclear regulations or equipment characteristics. For example, auxiliary building 120 may include fire-rated equipment and, as such, may be installed with extensive fire protection systems, while auxiliary building 130 does not and lacks such systems. Similar divisions among seismic ratings, radiological controls, permeability, etc. may be used in different buildings 120, 130, 140, etc.

Transverse penetration shafts 125, 126, 135, and 136 may provide necessary connections between buildings 110, 120, 140, and 140 through holes or penetrations in shafts 5. Alternatively, as shown in FIG. 2, some buildings may be isolated, such as control building 140 with no horizontal penetrations. As an example, transverse penetration shaft 125 may connect a main steam leg from reactor 142 to a turbine and condenser in auxiliary building 120. Or, for example, transverse penetration shaft 126 may connect control rod drives or pumps below reactor 142 to power sources in auxiliary building 130. Transverse penetration shafts 125, 126, 135, and 136 may be formed through a similar process as shafts 5 and may also be underground. These shafts may alternatively be formed through other horizontal boring and/or tunneling, which tends to be far less burdensome or difficult than vertical boring, to create passages of, for example, 3 meter diameters. Transverse penetration shafts 125, 126, 135, and 136 may use regulatory-grade seals and safety systems, including steel lining and other radiation controls, to maintain isolation and containment for reactor building 110.

FIG. 3 is a profile schematic of example embodiment plant 100 showing a subset of buildings 110, 120, and 130 below ground 90. As shown in FIG. 3, auxiliary buildings 120 and 130 may include a plurality of levels or floors 115 at particular axial heights. Each floor 115 may house and support equipment appropriate for its axial level. For example, transverse penetration 125 may connect a main steam leg to a turbine housed on floor 115 at the same axial level in building 130. Adjacent floors 115 may house lower pressure turbines and/or condensers. In this way, specific plant components and interoperative systems may be vertically arranged in a single building across multiple floors 115.

Floors 115 may be modularly built and then installed in single pieces. For example, full floors with equipment preinstalled may be shipped to ground 90 as shaft 5 is constructed, and each floor 115 may be sequentially descended, such as by overhead crane, and attached to the installed shaft 5. As such, floors 115 may be constructed in whole, potentially with all necessary equipment and connections, at another site and brought to shaft 5 for installation as a single piece on site in shaft 5. Alternatively, floors 115 may be constructed in parallel with shaft 5, lowered with the same, and finished piecewise at final elevation. Floors 115 may seat into a keyway, buttress, or extrusions 116 secured directly in shaft 5, potentially at several perimeter points of each floor 115. Such extrusions 116 may seismically isolate each floor 115 from each other and/or shaft 5. Floors 115 may be solid or include passages for personnel passage or equipment connection on adjacent floors 115. Floors 115 may also be fairly identical and modular, further aiding in large-scale prefabricated construction.

Because shafts 5 of the various buildings may be constructed in parallel with excavation using a VSM, additional systems such as electrical connections, piping, data lines, etc. may be added to walls of shafts 5 during construction or following descent into the excavated hole. For example, HVAC, electric, and chilled water may be piped between floors 115 along walls of shaft 5 to systems on two adjacent floors 115. Piping between adjacent floors 115 may be installed following descent or incrementally built along shaft 5 as shaft 5 itself is vertically constructed and descended in parallel with excavation. In this way, all systems between floors 115 may be connected as the systems and floors 115 themselves are installed.

As seen, the use of VSM in constructing example embodiment facility 100 permits relatively less-expensive creation of multiple shafts 5 and related buildings. Through proper connections, these buildings may operate as a partitioned nuclear power plant with minimal above-ground exposure. The small sizing and overall vertical orientation of shafts 5 may not impede parallel construction, as floors 115 can be assembled and installed modularly in shafts 5.

Example embodiments and methods thus being described, it will be appreciated by one skilled in the art that example embodiments may be varied and substituted through routine experimentation while still falling within the scope of the following claims. For example, any number of different buildings at, above, and/or below ground can be used in example embodiment facilities. Such variations are not to be regarded as departure from the scope of these claims.

What is claimed is:

1. A nuclear facility comprising:
a reactor building including in a vertical shaft built downward from its top; and
a nuclear reactor housed in the reactor building.

2. The nuclear facility of claim 1, wherein the vertical shaft is built with a vertical shaft sinking machine (VSM), wherein the shaft includes a wedge at a lower vertical edge, and wherein the reactor building includes a basemat sealing a vertical bottom of the shaft.

3. The nuclear facility of claim 1, wherein the reactor building extends vertically below ground surrounding the reactor building and wherein the nuclear reactor is entirely below the ground.

4. The nuclear facility of claim 1, wherein the vertical shaft has an inner diameter of up to about 22 meters, and wherein the nuclear reactor has an outer diameter of less than 22 meters.

5. The nuclear facility of claim 4, wherein the nuclear reactor is at least one of, a simplified boiling water reactor having integral coolant connection and using isolation condensers as passive cooling systems, a sodium cool fast reactor, and a small modular reactor.

6. The nuclear facility of claim 1, further comprising:
an auxiliary building including in a vertical shaft built downward from its top; and
a transverse connection between the auxiliary building and the reactor building.

7. The nuclear facility of claim 6, wherein the auxiliary building includes a plurality of floors vertically separated from one another and joined to the vertical shaft of the auxiliary building.

8. The nuclear facility of claim 7, wherein the plurality of floors are modular with different equipment installed on each floor.

9. The nuclear facility of claim 6, wherein all equipment in the auxiliary building has a shared nuclear safety classification.

10. The nuclear facility of claim 1, further comprising:
a containment structure inside the reactor building and housing the nuclear reactor; and
a control building including a vertical shaft built downward from its top entirely separated from the reactor building.

11. A method of constructing a nuclear facility, the method comprising:
creating a vertical shaft for a reactor building by fabricating the shaft from its top at ground level and descending the shaft into the ground while excavating the ground at a bottom of the shaft, wherein the vertical shaft is fabricated of materials that retain physical characteristics when exposed to operating and transient nuclear reactor conditions and is impermeable to leakage from the reactor.

12. The method of claim 11, wherein the vertical shaft includes a wedge at a lower vertical edge, and wherein the shaft is flooded with water during excavation.

13. The method of claim 11, further comprising:
creating a vertical shaft for an auxiliary building by fabricating the shaft for the auxiliary building from its top at ground level and descending the shaft for the auxiliary building into the ground while excavating the ground at a bottom of the shaft for the auxiliary building; and
connecting the vertical shaft for the reactor building and the vertical shaft for the auxiliary building with a transverse connection extending underground between the buildings.

14. The method of claim 13, further comprising:
installing a plurality of floors in the vertical shaft for the auxiliary building by vertically lowering each floor into the vertical shaft for the auxiliary building and attaching each floor to the vertical shaft for the auxiliary building.

15. The method of claim 14, wherein the plurality of floors are modular with different equipment installed on each floor prior to the installing the plurality of floors, and, wherein all the different equipment has a shared nuclear safety classification.

15. The method of claim 11, further comprising:
pouring a basemat at a vertical bottom of the vertical shaft, wherein the basemat is configured to prevent further relocation of radioactive components into the ground.

16. The method of claim 11, further comprising:
installing a nuclear reactor in the vertical shaft, wherein the vertical shaft has an inner diameter of up to about 22 meters, and wherein the nuclear reactor has an outer diameter of less than 22 meters.

17. The method of claim 16, wherein the nuclear reactor is at least one of, a simplified boiling water reactor having integral coolant connection and using isolation condensers as passive cooling systems, a sodium cool fast reactor, and a small modular reactor.

18. The method of claim 16, further comprising:
forming a containment structure in the vertical shaft around the nuclear reactor.

19. The method of claim 16, wherein the installing placed the nuclear reactor completely below ground.

20. A method of provisioning a nuclear facility having one or more vertical shafts containing a nuclear reactor, the method comprising:
fabricating a floor configured to secure to one of the vertical shafts, wherein the fabricating includes installing nuclear equipment on the floor outside of the vertical shaft; and providing the floor to a site where the vertical shaft is formed.
